(19) United States
(12) Patent Application Publication
(10) Pub. No.: US 2004/0043215 A1
(43) Pub. Date: Mar. 4, 2004

(54) Trihaloperoxyacetic acid oxidation of carbonaceous materials

(76) Inventors: Deepak Tandon, Kennesaw, GA (US); Bollepalli Srinivas, Marietta, GA (US); Kevin Hathcock, Woodstock, GA (US)

Correspondence Address: NEEDLE & ROSENBERG, P.C., SUITE 1000, 999 PEACHTREE STREET, ATLANTA, GA, 30309-3915, US

(21) Appl. No.: 10/229,558

(22) Filed: Aug. 28, 2002

(51) Int. Cl. B32B 25/02

(52) U.S. Cl. 428/403

(57) ABSTRACT

The invention provides methods for the oxidation of carbonaceous materials with a trihaloperoxyacetic acid and similarly provides several surface modified carbonaceous materials resulting therefrom.

### FIELD OF THE INVENTION

The present invention relates to the surface modification of various carbonaceous materials and compounds. More specifically, the invention provides methods for the oxidation of carbonaceous materials with a trihaloperoxyacetic acid and similarly provides several surface modified carbonaceous materials resulting therefrom.

### BACKGROUND OF THE INVENTION

The surface modification of carbonaceous materials has been widely explored as a means for achieving desired chemical and physical properties not normally exhibited by carbonaceous materials. Specifically, the oxidation of carbonaceous materials has been perceived as a potential means for enhancing the self-dispersibility and long-term stability of aqueous dispersions containing said carbonaceous materials. Traditionally, various additives, dispersants and surfactants were used to improve the dispersibility and long-term stability of carbonaceous materials in waterborne systems. However, these materials only show marginal improvement in the dispersibility and stability of such carbonaceous materials. Additionally, such additives can increase the viscosity of a dispersion, which would be undesired for particular end uses such as ink dispersions and, in particular, ink jet formulations. Moreover, these additives add significant costs and are therefore economically unfavorable as well.

To this end, several attempts have been made at oxidizing carbonaceous materials. However, these existing methods similarly produce only limited results with relatively low levels of surface oxidation. Therefore, it is one object of the present invention to provide an improved process for the formation of oxidized carbonaceous materials. Additionally, the processes of the prior art only succeed in providing oxidized carbonaceous materials having a low degree of surface substitution. To that end, it is a further object of the present invention to provide oxidized carbonaceous materials having a surprisingly substantially improved degree of surface modification and thereby resulting in superior dispersibility and long-term stability in waterborne systems.

### SUMMARY OF THE INVENTION

Among other aspects, the present invention is based upon methods for the preparation of oxidized carbonaceous materials using trihaloperoxyacetic acid and similarly provides several inventive surface modified carbonaceous materials resulting therefrom.

In a first aspect, the present invention provides a surface modified carbonaceous material, comprising a plurality of oxygen containing functional groups of the general formula —OM, —(CO)OM, or a combination thereof, surface bonded thereto, wherein M is hydrogen or a cationic species and wherein the surface atomic concentration of oxygen is at least approximately 2.0% relative to the total surface atomic concentration of the surface modified carbonaceous material.

In a second aspect, the present invention further provides a process for the manufacture of a surface modified carbonaceous material. The process comprises contacting a carbonaceous material with a trihaloperoxyacetic acid under conditions effective to provide a surface treated carbonaceous material comprising a plurality of oxygen containing functional groups of the general formula —OH, —COOH, or a combination thereof, surface bonded thereto.

In still a third aspect, the present invention provides an aqueous composition, comprising the surface modified carbonaceous materials disclosed herein.

Additional advantages of the invention will be obvious from the description, or may be learned by practice of the invention. Additional advantages of the invention will also be realized and attained by means of the elements and combinations particularly pointed out in the appended claims. Therefore, it is to be understood that both the foregoing general description and the following detailed description are exemplary and explanatory of certain embodiments of the invention, and are not restrictive of the invention as claimed.

### BRIEF DESCRIPTION OF THE FIGURES

The appended Figures, which are incorporated in and constitute part of the specification, illustrate the effectiveness of the process of the present invention to provide oxidized carbonaceous materials by plotting the X-ray Photoelectron Spectroscopy (XPS) spectrum of an oxidized carbonaceous material of the present invention.

FIG. 1 is a plot of the XPS spectrum of the carbon black used to prepare the surface modified carbonaceous material of Example 2.

FIG. 2 is a plot of the XPS spectrum of the surface modified carbon black produced in Example 2.

FIG. 3 is a plot of the XPS spectrum of the carbon black used to prepare the surface modified carbonaceous material of Example 2, indicating the relative percentages and types of oxygen species that are present in the surface bonded substituents.

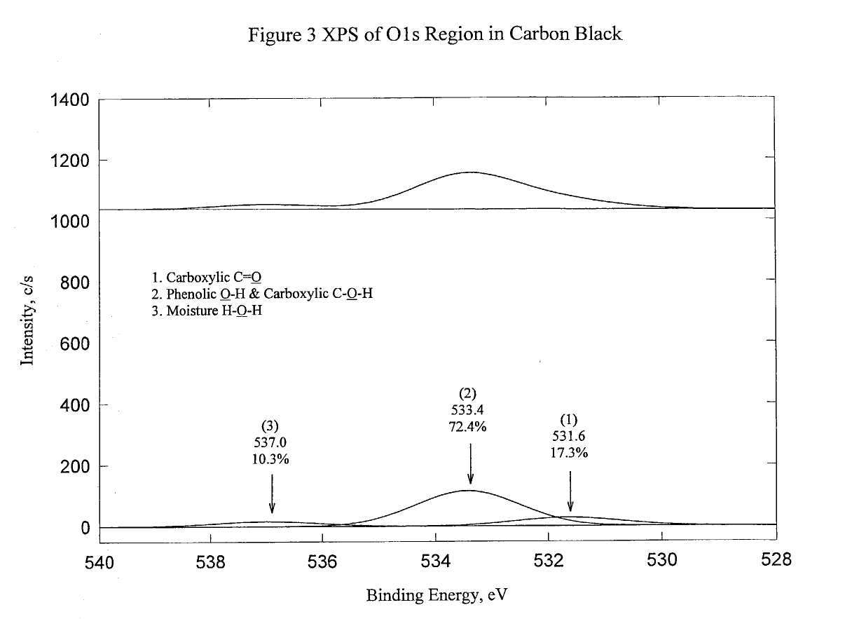

FIG. 4 is a plot of the XPS spectrum of the surface modified carbon black prepared in Example 2, indicating the relative percentages and types of oxygen species that are present in the surface bonded substituents.

FIG. 5 is an illustration of a reaction scheme according to one embodiment of the present invention

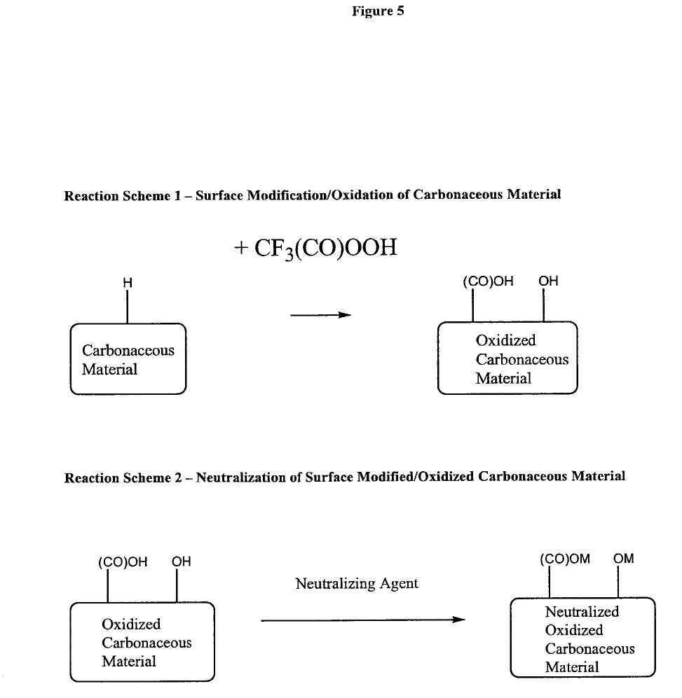

### DETAILED DESCRIPTION OF THE INVENTION

The present invention may be understood more readily by reference to the following detailed description and any examples provided herein. It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular forms “a,” “an,” and “the” comprise plural referents unless the context clearly dictates otherwise. For example, reference to a component in the singular is intended to comprise a plurality of components.

Ranges may be expressed herein as from “about” or “approximately” one particular value and/or to “about” or “approximately” another particular value. When such a range is expressed, another embodiment comprises from the one particular value and/or to the other particular value. Similarly, when values are expressed as approximations, by use of the antecedent “about,” it will be understood that the particular value forms another embodiment.

As used herein, a weight percent of a component, unless specifically stated to the contrary, is based on the total weight of the formulation or composition in which the component is included.

As used herein, the term “flocculation” refers to the combination or aggregation of suspended or dispersed particles in such a way that they form small aggregates or agglomerates.

As used herein, the term or phrase “surface modified” refers to the incorporation of desired functional groups surface bonded to a carbonaceous material as defined herein.

As used herein, the term “oxidized” refers to the presence of oxygen containing functional groups chemically bonded to the surface of a carbonaceous material.

As used herein, the term “surface bonded” refers to a substituent that is substantially bonded, either covalently or ionically, primarily or only to the outer surface of the carbonaceous material particle. To this end, a substituent that is “surface bonded” is substantially absent from the inside or core of the carbonaceous material particle.

As used herein, the phrase “oxygen containing functional group” refers to a hydroxyl or carboxyl functional group or a derivative thereof, or any combination thereof. For example, an oxygen containing functional group may be an —OH group, a —(CO)—OH, or a combination thereof. Alternatively, the oxygen containing functional group can be a derivative of the hydroxyl or carboxyl group, represented by the general formula OM, —(CO)—OM, or a combination there of, wherein M can be any known cationic species, including for example, ammonium or the group (I) alkali metals, e.g., sodium, lithium, potassium, rubidium, cesium and francium.

As used herein, the term “cationic species” refers to a positively charged molecular or elemental species capable of forming an ionic bond with an oxygen substituent or functional group as defined herein. Examples of cationic species suitable for use in the present invention include, without limitation, ammonium, the group I alkali metals, e.g., lithium, sodium, potassium, rubidium, cesium and francium, as well as organic bases such as dimethylethanol amine (DMEA) and triethanol amine (TEA)

As used herein, the term “XPS” refers to X-ray Photoelectron Spectroscopy. Accordingly, all XPS measurements disclosed herein have been conducted using the Physical Electronics 5802 Multitechnique with Al Kα X-ray source.

As used herein, the term “carbonaceous material” is intended to include, without limitation, i) carbonaceous compounds having a single definable structure; or ii) aggregates of carbonaceous particles, wherein the aggregate does not necessarily have a unitary, repeating, and/or definable structure or degree of aggregation. For example, a carbon black material as used herein can be a carbon black compound having a definable structure or, alternatively, can also be an aggregate of carbonaceous particles wherein the exact structure or degree of aggregation is unknown.

As used herein, the term “optional” or “optionally” means that the subsequently described event or circumstance may or may not occur, and that the description includes instances where said event or circumstance occurs and instances where it does not. For example, the phrase “optionally substituted lower alkyl” means that the lower alkyl group may or may not be substituted and that the description includes both unsubstituted lower alkyl and lower alkyl where there is substitution.

As used herein, by use of the term or phrase “effective,” “effective amount,” or “conditions effective to” it is meant that such amount or reaction condition is capable of performing the function of the compound or property for which an effective amount is expressed. As will be pointed out below, the exact amount required will vary from one embodiment to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

As indicated above, the present invention relates to the surface modification of various carbonaceous materials and/or compounds. More specifically, the present invention relates to the surface modification of carbonaceous materials by oxidizing a carbonaceous material under conditions effective to provide a plurality of oxygen containing functional groups surface bonded thereto. To this end, in a first aspect, the invention provides a process for the manufacture of these surface modified carbonaceous materials.

Accordingly, in one embodiment, the present invention provides a process for the manufacture of a surface modified carbonaceous material, comprising first contacting a carbonaceous material with a trihaloperoxyacetic acid under conditions effective to provide a surface treated carbonaceous material comprising a plurality of oxygen containing functional groups of the general formula —OH, —COOH, or a combination thereof, surface bonded thereto. To this end, it will be appreciated upon practicing the several embodiments disclosed herein that a trihaloperoxyacetic acid is a much stronger oxidizing agent relative to those previously used in existing processes and, as such, the process of the present invention advantageously provides levels of surface substitution and/or modification that were not previously achievable in the art.

According to this and other embodiments of the invention that will be described below, trihaloperoxyacetic acids suitable for use in the process of the present invention include trifluoroperoxyacetic acid, trichloroperoxyacetic acid and tribromoperoxyacetic acid. However, in a preferred embodiment, the trihaloperoxyacetic acid is trifluoroperoxyacotic acid.

To this end, it will be appreciated that the optimum reaction conditions for providing the plurality of oxygen containing function groups surface bonded to the carbonaceous material will of course vary according to the particular carbonaceous material employed. However, one of ordinary skill in the art will be able to readily obtain such optimum conditions through no more than routine experimentation.

Nonetheless, in one embodiment, the preferred reaction conditions for reacting the trihaloperoxyacetic acid with the carbonaceous material comprises first preparing a slurry of the carbonaceous material in an aqueous medium. For example, the carbonaceous material can be introduced into an aqueous medium, e.g., distilled water, and followed by heating the resulting mixture to a temperature in the range of from at least approximately 60° C. to approximately 90° C., including such temperatures as 65° C., 70° C., 75° C., 80° C., and 85° C.

To this end, it is understood that the water can be present in any amount suitable for preparing a slurry of the carbonaceous material. For example, in one embodiment, the weight ratio of water to carbonaceous material can be as much as 10:1. In an alternative embodiment, the weight ratio of water to carbonaceous material is at least 2:1. Additionally, if desired, the mixture of carbonaceous material and aqueous medium can also be stirred at this point as well.

Once the slurry of carbonaceous material has been prepared as set forth above, a trihaloperoxyacetic acid, such as trifluoroperoxyacetic acid, can be added to the slurry. It will be understood that this reaction is exothermic in nature and, as such, the trihaloperoxyacetic should be added in a drop wise manner in order to prevent an overly violent reaction or higher than desired temperature. To this end, it is preferred that the reaction mixture be maintained at a temperature in the range of from at least approximately 60° C. to approximately 90° C., including such temperatures as 65° C., 70° C., 75° C., 80° C. and 85° C., during this dropwise addition of the trihaloperoxyacetic acid. At this stage, it will also be appreciated that as an exothermic reaction, it may need to be placed in an ice bath or otherwise cooled in order to maintain the reaction at a desired temperature.

Any amount of the trihaloperoxyacetic acid can be added to the reaction mixture, provided it is present in a sufficient amount relative to the carbonaceous material to at least substantially react with the carbonaceous material. As such, the trihaloperoxyacetic acid is preferably added in excess relative to the amount if carbonaceous material. For example, in one embodiment, the weight ratio of trifluoroperoxyacetic acid relative to the carbonaceous material is approximately 10:1.

After addition of the trihaloperoxyacetic acid is complete, the reaction will typically proceed to completion within approximately 2 hours. However, it is further preferred to continuing stirring the reaction for a period of time in the range of from at least 6 hours to approximately 24 hours while continuing to maintain the reaction mixture at a temperature of at least approximately 60° C. Other time periods can of course be used, including such ranges as from 6 to 8 hours, 6 to 10 hours, or even 12 to 24 hours. This additional time ensures the at least substantial completion of the reaction.

As indicated above, suitable trihaloperoxyacetic acids for use in the process of the present invention include commercially available trifluoro, trichloro or tribromo peroxyacetic acids. Alternatively, a suitable trihaloperoxyacetic acid can be readily prepared by reacting a commercially available trihaloacetic acid and commercially available hydrogen peroxide. To this end, if the desired trihaloperoxyacetic acid is to be prepared, a trihaloacetic acid such as trifluoroacetic acid, is preferably placed in an ice bath to cool the acid to a temperature below at least ambient or room temperature. Once the desired reaction temperature is achieved, commercially available hydrogen peroxide is then added dropwise to the trihaloacetic acid. Although any commercially available hydrogen peroxide can be used in the formation of trihaloperoxyacetic acid, in a preferred embodiment, the hydrogen peroxide is a commercially available 50% hydrogen peroxide. It will be appreciated that the preferred amount of hydrogen peroxide used will be dependent on the concentration of the hydrogen peroxide chosen. However, such optimum amount will be readily determined by one of ordinary skill in the art through no more than routine experimentation. To this end, it is preferred that the hydrogen peroxide and trihaloacetic acid each be present in approximately a 1:1 molar ratio.

After introduction of the hydrogen peroxide to the trihaloacetic acid, the reaction mixture is then allowed to stand for a period of time in the range of from approximately 2 to 24 hours to ensure completion of the reaction. Other time periods can of course be used, including such ranges as from 6 to 8 hours, 6 to 10 hours, or even 12 to 24 hours.

As previously indicated herein, the process of the present invention can also carried out with a variety of carbonaceous materials. To this end, any carbonaceous compound or material can be used provided there are sufficient C—H edge sites capable of interacting with the trihaloperoxyacetic acid under conditions effective to provide a desired surface modified carbonaceous material. It should also be understood that the process of the present invention is not limited to use with unoxidized carbonaceous compounds and materials, but rather, can also be used to further enhance the level of surface bonded oxygen containing functional groups present on previously oxidized carbonaceous compounds and materials.

Accordingly, it is preferred that the carbonaceous material have a surface area of at least approximately 25 m²/g as measured by ASTM-D4820. In a more preferred embodiment, when measured by ASTM-D4820, the carbonaceous material will have a surface area of at least approximately 100 m²/g. In still a more preferred embodiment, the surface area of the carbonaceous material will be greater than approximately 200 m²/g when measured according to the ASTM-D4820 method.

Specific examples of suitable carbonaceous materials include, without limitation, carbon fibers, activated charcoal, finely divided carbon, carbon black, graphite, fullerinic carbons, and nanocarbons. In a preferred embodiment, the carbonaceous material is a carbon black having a surface area greater than approximately 200 m²/g and an oil adsorption of at least 60 ml/100 g as measured by ASTM-D2414.

In accordance with the process of the present invention, it may be desired, although not required, to further modify the surface bonded oxygen containing functional substituents to provide a salt thereof. To this end, in an alternative embodiment, the process can further comprise the step of treating the surface bonded hydroxyl or carboxyl substituents of the general formula —OH or (CO)—OH, with one or more neutralizing agents under conditions effective to provide an oxygen containing functional substituent of the general formula —OM, (CO)—OM, or a combination thereof, wherein M represents a cationic species as defined above.

Suitable neutralizing agents include, without limitation, alkali hydroxides, such as sodium hydroxide, potassium hydroxide, lithium hydroxide, ammonium hydroxide; alkali carbonates and bicarbonates, such as sodium bicarbonate, potassium bicarbonate, and the like; as well as organic bases such, as dimethylethyl amine and triethanol amine. Although any commercially available neutralizing agent and concentration thereof will suffice, the neutralizing agent is preferably a 0.5M, 0.75M, 1M, 1.25M or 1.5M solution of sodium hydroxide.

To this end, the chemistry and conditions required for neutralization of the hydroxyl and or carboxyl substituents is commonly known to one of ordinary skill and need not be discussed at length herein. Therefore, it will be appreciated that arriving at the optimum process conditions for achieving the desired degree and kind of neutralization will require no more than routine experimentation. However, in a preferred embodiment, the neutralizing agent is used in a relative amount and strength sufficient to provide a resulting pH of at least 8.

If desired, the surface modified carbonaceous material containing a plurality of oxygen containing functional groups as described herein, e.g., the hydroxyl and/or carboxyl groups, or the salts thereof, can be washed with distilled water, filtered and/or dried in order to obtain substantially purified and/or isolated surface modified product.

In an alternative embodiment, the trihaloperoxyacetic acid to be reacted with the carbonaceous material can be formed in situ so as to allow the process as described above to be performed in a single reaction. Accordingly, if desired, the process of the present invention can be performed by introducing a suitable trihaloacetic acid as defined herein, hydrogen peroxide and a carbonaceous material as defined above, into a single reaction mixture under conditions effective to provide the trihaloperoxyacetic acid in situ and to subsequently provide a surface modified carbonaceous material comprising a plurality of carboxyl and/or hydroxyl substituents surface bonded thereto.

It will once again be appreciated that the optimum reaction conditions required for in situ formation of the trihaloperoxyacetic acid and subsequent reaction with the carbonaceous material will, of course, vary depending on the particular concentration of the hydrogen peroxide and/or the particular carbonaceous material selected. To this end, arriving at such optimum conditions would be readily obtainable by one of ordinary skill in the art or otherwise can be obtained through no more than mere routine experimentation.

Regardless of the embodied process used for preparing the surface modified carbonaceous material, the resulting surface modified material containing the plurality of surface bonded hydroxyl and/or carboxyl substituents can be further neutralized with a suitable neutralizing agent as previously described above. Therefore, those embodiments comprising the in situ formation of the trihaloperoxyacetic acid and the subsequent reaction of the trihaloperoxyacetic acid with the carbonaceous material can further comprise the step of treating the surface bonded hydroxyl or carboxyl substituents with one or more neutralizing agents under conditions effective to provide an oxygen containing functional group of the general formula —OM, and/or —(CO)—OM surface bonded thereto, wherein M once again represents a cationic species as defined herein, such as lithium, sodium, potassium or ammonium.

Once again, as previously described herein, neutralizing agents suitable for use in the processes of the present invention include, without limitation, alkali hydroxides, such as sodium hydroxide, potassium hydroxide, lithium hydroxide, ammonium hydroxide; alkali carbonates and bicarbonates, such as sodium bicarbonate, potassium bicarbonate, and the like; as well as organic bases such, as dimethylethyl amine and triethanol amine. Although any commercially available neutralizing agent and concentration thereof will suffice, the neutralizing agent is preferably a 0.5M, 0.75M, 1M, 1.25M or 1.5M solution of sodium hydroxide.

Additionally, as set forth above, the process comprising the in situ formation of the trihaloperoxyacetic acid and the subsequent reaction with a carbonaceous material to provide a surface modified carbonaceous material can further comprises the steps of washing with distilled water, filtering and/or drying the desired surface modified carbonaceous material in order to obtain substantially purified and/or isolated product.

In an alternative aspect, the present invention also provides the surface modified carbonaceous materials that result from the aforementioned inventive processes. To this end, the surface modified carbonaceous materials according to the present invention exhibit several advantageously improved characteristics over those previously obtained in the art.

In accordance with this aspect, in one embodiment, the invention provides a surface modified carbonaceous material comprising a plurality of hydroxyl and/or carboxyl substituents surface bonded thereto.

Additionally, in an alternative embodiment, the invention similarly provides a surface modified carbonaceous material comprising a plurality of surface bonded oxygen containing functional groups of the general formula —OM, —(CO)—OM, or a combination thereof, wherein M represents a cationic species as defined herein, including without limitation, ammonium and the group (I) alkali metals such as lithium, sodium, and potassium.

In an alternative embodiment, the degree of surface modification, e.g., measurement of surface bonded oxygen containing functional groups, can be measured by XPS (X-ray Photoelectron Spectroscopy). Accordingly, in a preferred embodiment, the surface modified carbonaceous materials of the present invention exhibit a surface atomic concentration of oxygen, as measured by XPS (using the Physical Electronics 5802 Multitechnique with Al Kα X-ray source), greater than at least approximately 2.0% relative to the total surface atomic concentration of the surface modified carbonaceous material. In a more preferred embodiment, the surface atomic concentration of oxygen is greater than at least approximately 6.0%. In still a more preferred embodiment, the surface atomic concentration of oxygen is greater than at least approximately 9.0%. To this end, it is understood that the level of surface modification or substitution achieved will ultimately be dependent on a number of variables, including the surface area of the initial carbonaceous material. That is to say, the level of surface modification will typically increase relative to an increase in the initial surface area of the carbonaceous material.

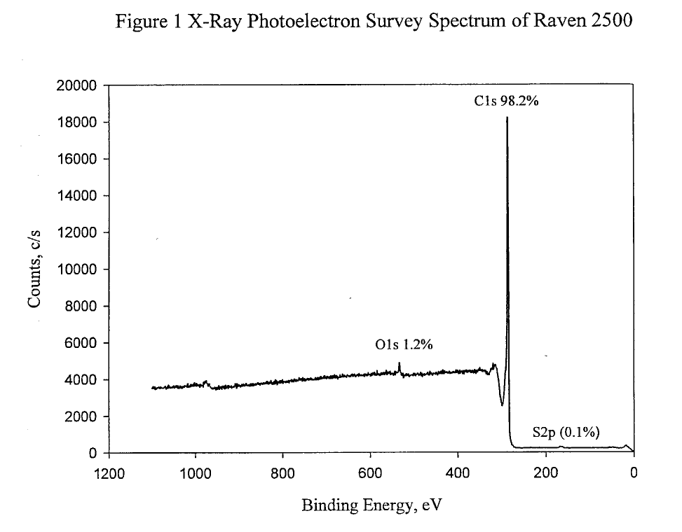

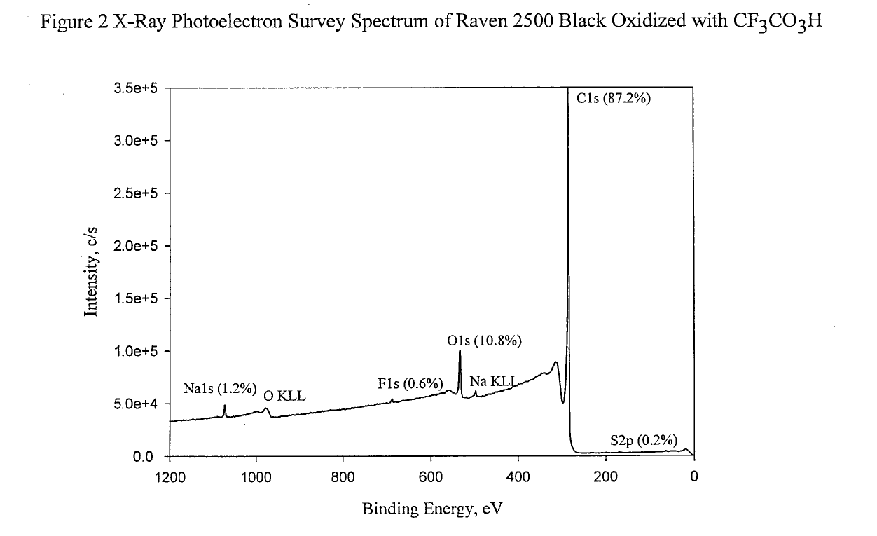

For example, with specific reference to FIG. 2, the surface atomic concentration of oxygen present within the surface modified carbonaceous material of Example 2 is approximately 10.8% relative to the total surface atomic concentration of the surface modified carbon black compound. When compared to FIG. 1, which similarly indicates the XPS surface atomic concentration spectrum of the carbon black compound prior to surface modification, i.e., 1.2%, it is revealed that, in accordance with one embodiment as set forth in Example 2, the surface atomic concentration of surface bonded oxygen species has been enhanced by approximately 900%, from approximately 1.2% to approximately 10.8%.

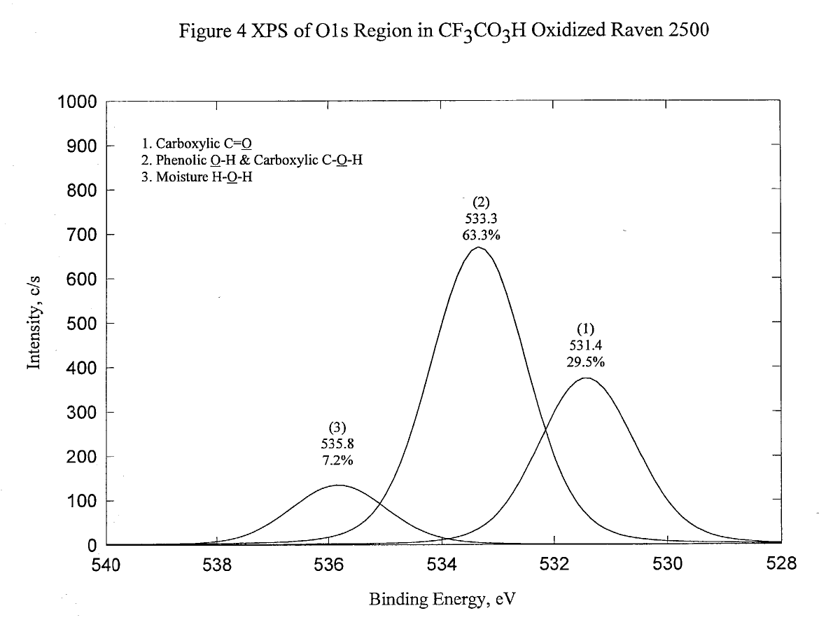

Furthermore, specific reference to FIG. 4 reveals that approximately 92.8% (63.3%+29.5%) of the surface bonded oxygen species measured in FIG. 2 is present as a component of a hydroxyl or carboxyl functionality. Therefore, it follows that surface modified carbon black of Example 2 has a surface atomic concentration of oxygen present within the surface bonded hydroxyl and carboxyl substituents of approximately 9.9%, i.e., 92.8% of the 10.8% surface atomic concentration of oxygen species measured in FIG. 2.

As previously described herein, the carbonaceous compound or material can be any carbonaceous compound or material provided it contains sufficient C—H edge sites capable of interacting with trifluoroperoxyacetic acid under conditions effective to provide a desired surface modified carbotiaceous material.

Accordingly, it is preferred that the carbonaceous material have a surface area of at least approximately 25 m²/g as measured by ASTM-D4820. In a more preferred embodiment, when measured by ASTM-D4820, the carbonaceous material will have a surface area of at least approximately 100 m²/g. In still a more preferred embodiment, the surface area of the carbonaceous material will be greater than approximately 200 m²/g when measured according to the ASTM-D4820 method.

Specific examples of suitable carbonaceous materials include, without limitation, carbon fibers, activated charcoal, finely divided carbon, carbon black, graphite, fullerinic carbons, and nanocarbons. In a preferred embodiment, the carbonaceous material is a carbon black having a surface area greater than approximately 200 m²/g and an oil adsorption rate of at least 60 ml/100 g as measured by ASTM-D2414.

Among the several advantages that are obtained by practicing the present invention, the surface modified carbonaceous materials of the present invention exhibit an improved storage stability and dispersibility in aqueous and waterborne formulations. Specifically, when tested after storage periods of at least one week, one month and even three months, an aqueous dispersion containing the surface modified materials of the present invention will exhibit substantially no visual flocculation.

Likewise, after similar storage periods of at least one week, one month and even three months, an aqueous dispersion of a surface modified carbonaceous material as described herein will advantageously pass through a filter having a mesh size in the range of from approximately 8 microns to approximately 10 microns, such as a Whatman #42 filter paper, leaving substantially no visual agglomerates of surface modified carbonaceous material.

Accordingly, these and other advantageous properties of the inventive surface modified materials described herein facilitate their viability in several aqueous formulations. As such, in still another aspect, the present invention further provides several end use formulations for the surface modified carbonaceous materials set forth above.

To this end, the present invention also provides an aqueous composition comprising a surface modified carbonaceous material as set forth above and water. The self dispersibility and long term stability of a surface modified carbon black according to the present invention is particularly suited for this embodiment as it can be used to provide a waterborne ink formulation suitable for use in, among other applications, inks and in particular, ink jet printing and recording technology.

Moreover, when an ink dispersion is used in ink jet applications, it is necessary to eject the ink in the form of stable droplets through a minute orifice in the ink jet recording head or device. Therefore, it is very important that the ink formulation, and the pigment dispersion contained therein, remain dispersed and stable so as not to flocculate and potentially clog the orifice. Advantageously, the self-dispersing surface modified carbonaceous materials of the present invention remain stable indefinitely when dispersed in waterborne systems. Additionally, these aqueous dispersions do not require the use of additional dispersing agents to remain stable, which may undesirably increase the viscosity of such a formulation. Moreover, the need for such additional dispersing agents would render such dispersions economically undesirable due to the increased costs associated therewith.

When the surface modified compounds and materials of the present invention are utilized in an aqueous dispersion, the surface modified carbonaceous compound, e.g., carbon black, can surprisingly be present in an amount of from approximately 1 wt % to approximately 40 wt. % relative to the entire aqueous dispersion. In a preferred embodiment, the dispersion comprises in the range of from approximately 10 wt. % to approximately 40 wt. % of the surface modified carbon black. Furthermore, as indicated above, the aqueous dispersion remains stable indefinitely, exhibiting substantially no visual flocculation.

Likewise, an aqueous dispersion according to these embodiments would therefore preferably comprise water in an amount ranging from at least approximately 10% to approximately 99.0% by weight of the entire aqueous formulation.

If desired, aqueous dispersions and formulations comprising the surface modified carbonaceous materials of the present invention can further comprise one or more humectants selected from ethylene glycol, diethylene glycol, propylene glycol, dipropylene glycol, polyethylene glycol, polypropylene glycol, alcohol derivatives such as ethanol, propanol, isopropanol and the like, and cellosolve. It will be appreciated that the humectant is optionally introduced as a means to maintain a substantially constant moisture content of the aqueous dispersions and formulations.

Additionally, a waterborne formulation or dispersion according to the present invention can optionally contain one or more additional additives such as a polymer binder; e.g., Joncryl J-61 (Acrylic polymer, manufacture and available from S. C. Johnson Wax.), surfactants such as Surfynol 695 or Surfynol 7608, and one or more biocide compositions.

To this end, the polymer binder acts as a film forming component allowing a formulation such, as an aqueous ink, to have substantial fastness and staying potential thus allowing the ink to bind to the medium once water and other optional solvents have evaporated.

It will be appreciated that the aqueous dispersions comprising the surface modified carbonaceous materials of the present invention can be prepared using any milling or dispersing machine known to one of ordinary skill in the art, including without limitation, shear stress machines such as a two or three roll mill, machines which disperse pigment particles with impact strength caused by the collision between media such as glass beads, zirconia beads, steel beads, agate beads, such as a ball mill or pearl mill, or even with machines that finely disperse pigment particles with a collision force or a shear stress among the pigment particles or between the pigment particles and a vehicle or a wall surface, such as a kneader or an extruder.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.); however, some errors and deviations may have occurred. Unless indicated otherwise, parts are parts by weight, temperature is degrees C. or is at ambient temperature, and pressure is at or near atmospheric.

The amount or property of a compound as provided herein means such amount as that capable of performing the function of the compound or property for which an amount is expressed. As will be pointed out below, the exact amount required will vary from process to process, depending on recognized variables such as the compounds employed and the processing conditions observed. However, an appropriate amount may be determined by one of ordinary skill in the art using only routine experimentation.

### Example 1

### Preparation of Trifluoroperoxyacetic Acid

500 mL of trifluoroacetic acid was placed in a 1-liter flat-bottomed flask. The flask was then placed in an ice bath to cool. 500 mL of 50% hydrogen peroxide solution was slowly added dropwise into the flask containing trifluoroacetic acid. The resulting mixture was stirred continuously for a period of approximately 24 hours to ensure the reaction was complete.

### Example 2

### Preparation of Surface Modified Carbon Black

A mixture of 20 grams of dry carbon black (Raven 2500 Ultra, manufactured by Columbian Chemical Company, Marietta, Ga., U.S.A.) having a surface area of 270 m²/g as measured by ASTM-D4820 and an oil absorption of 67 ml/100 g as measured by ASTM-D2414 and 100 mL of deionized water was placed in a flat bottom flask. The mixture was then heated to a temperature of at least approximately 60° C. while stirring constantly. 200 mL of the trifluoroperoxyacetic acid prepared in Example 1 was slowly added dropwise to the mixture of carbon black and water. The resulting reaction mixture was then stirred continuously at a temperature of at least approximately 60° C. for at least approximately 24 hours. The reaction mixture was then cooled and filtered by washing with distilled water. The resulting carbon black cake was then re-dissolved in 300 mL of distilled water and subsequently neutralized with 1M NaOH solution. The resulting slurry was filtered and dried at a temperature of 110° C. for a period of approximately 2 hours.

The resulting product comprised a plurality of hydroxyl and carboxyl substituents of the general formula —ONa and —(CO)—ONa as indicated by XPS measurement wherein the surface atomic concentration of oxygen was approximately 10.8% and the surface atomic concentration of sodium was approximately 1.2% (See FIG. 2). Likewise, reference to FIG. 4 illustrates that approximately 92.8% of the surface bonded oxygen species measured in FIG. 2 were present as a component of the surface bonded hydroxyl and carboxyl substituents. Therefore, the surface modified carbon black product had a surface atomic concentration of oxygen present within the surface bonded hydroxyl and carboxyl substituents of approximately 9.9%, i.e., 92.8% of the 10.8% surface atomic concentration of oxygen species measured in FIG. 2.

### Example 3

### Sample Waterborne Dispersion Formulation

A sample waterborne dispersion formulation for use in an aqueous flexographic printing system would be prepared using a surface modified carbon black material as prepared in Example 2. The formulation would comprise:

| | |
|---|---|
| Water: | 20.4 wt % |
| Isopropyl Alcohol: | 3.7 wt. % |
| Surface Modified Carbon Black of Example 2: | 14.8 wt. % |
| Joncryl J-61 (Acrylic polymer, obtained from | 61.1 wt. % |
| S.C. Johnson Wax) | |

### Example 4

### Sample Ink Jet Formulation

A sample ink jet formulation for use in an ink jet printing system would be prepared using a surface modified carbon black material as prepared in Example 2. The formulation would comprise:

| | |
|---|---|
| Water | 73.55 wt. % |
| Glycerol | 8.00 wt. % |
| Diethylene Glycol | 10.00 wt. % |
| Surfynol 695 (Obtained from Air Products, | 3.00 wt. % |
| Allentown, Pennsylvania) | |
| Surfynol 7608 (Obtained from Air Products, | 2.50 wt. % |
| Allentown, Pennsylvania) | |
| Surface Modified Carbon Black of Ex. 2 | 2.75 wt.% |
| Biocide | 0.20 wt.% |

Throughout this application, where various publications are referenced, the entire disclosures of these publications are hereby incorporated by reference into this application for all purposes.

While this invention has been described in connection with preferred embodiments and specific examples, it is not intended to limit the scope of the invention to the particular embodiments set forth, but on the contrary, it is intended to cover such alternatives, modifications, and equivalents as may be included within the spirit and scope of the invention as defined by the appended claims. For example, there are numerous variations and combinations of components and or conditions, e.g., the carbonaceous material, reaction temperatures, reaction times, neutralizing agents and the like that can be used to optimize the results obtained from the described embodiments. To this end, one skilled in the art will appreciate that in practicing the present invention, only reasonable and routine experimentation will be required to optimize such conditions.

What is claimed is:

1. A process for the manufacture of a surface modified carbonaceous material comprising the step:
a) contacting a carbonaceous material with a trihaloperoxyacetic acid under conditions effective to provide a surface treated carbonaceous material comprising a plurality of oxygen containing functional groups of the general formula —OH, —COOH, or a combination thereof, surface bonded thereto.

2. The process of claim 1, wherein the trihaloperoxyacetic acid is trifluoroperoxyacetic acid, trichloroperoxyacetic acid, or tribromoperoxyacetic acid.

3. The process of claim 1, wherein the trihaloperoxyacetic acid is trifluoroperoxyacetic acid.

4. The process of claim 1, wherein prior to step a), the process comprises reacting a trihaloacetic acid with hydrogen peroxide under conditions effective to provide the trihaloperoxyacetic acid in situ.

5. The process of claim 1, wherein the carbonaceous material is carbon black, graphite, finely divided carbon, activated charcoal, fullerinic carbon or nanocarbon.

6. The process of claim 1, wherein the carbonaceous material is carbon black.

7. The process of claim 1, wherein the contacting of step a) comprises:
i) introducing a carbonaceous material into an aqueous reaction medium;
ii) maintaining the aqueous reaction medium of i) at a temperature of at least approximately 60° C.;
iii) introducing the trihaloperoxy acetic acid into the heated aqueous reaction medium of ii); and
iv) continuously stirring the heated aqueous reaction medium of iii) for a period of time in the range of from approximately 12 to approximately 24 hours.

8. The process of claim 1, further comprising:
b) treating the surface modified carbonaceous material produced in step a) with a neutralizing agent under conditions effective to provide a surface modified carbonaceous material comprising a plurality of oxygen containing functional groups of the general formula —OM, —(CO)OM, or a combination thereof, surface bonded thereto, wherein M is a cationic species.

9. The process of claim 8, wherein the cationic species is ammonium, sodium, potassium, or lithium.

10. The process of claim 8, wherein M is sodium.

11. The process of claim 8, wherein the neutralizing agent is sodium hydroxide solution having a concentration in the range of from approximately 0.75M to approximately 1.25M.

12. The process of claim 8, further comprising:
c) filtering and substantially drying the surface modified carbonaceous material produced in step b) at a temperature of at least approximately 100° C.

13. An aqueous composition, comprising:
a) a surface modified carbonaceous material, comprising a plurality of oxygen containing functional groups of the general formula —OM, —(CO)—OM, or a combination thereof, surface bonded thereto, wherein M is hydrogen or a cationic species and wherein the surface atomic concentration of oxygen, as measured by XPS, is at least approximately 2.0% relative to the total surface atomic concentration of the surface modified carbonaceous material; and
b) water.

14. The composition of claim 13, wherein the composition is an ink and wherein the composition further comprises at least one acrylic polymer and at least one organic solvent.

15. The composition of claim 13, wherein the composition is an aqueous dispersion and wherein the surface modified carbonaceous material is a surface modified carbon black.

16. The composition of claim 15, wherein the surface modified carbon black is present in an amount in the range of from approximately 1.0 wt. % to approximately 40.0 wt. %.
